(19) United States
(12) Patent Application Publication
(10) Pub. No.: US 2006/0203844 A1
(43) Pub. Date: Sep. 14, 2006

(54) Method and apparatus for downstream ethernet overlay in optical communications

(76) Inventors: Curtis D. Knittle, Superior, CO (US); Chris A. Cholas, Westminster, CO (US)

Correspondence Address: MORRISON & FOERSTER LLP, 755 PAGE MILL RD, PALO ALTO, CA, 94304-1018, US

(21) Appl. No.: 11/078,811

(22) Filed: Mar. 10, 2005

(51) Int. Cl. H04J 3/16

(52) U.S. Cl. 370/466

(57) ABSTRACT

In optical telecommunications networks using passive optical networks (PON), an optical wavelength band called the enhancement band (1539 to 1565 nm) is typically used to carry broadcast video signals in either analog television or QAM Digital Video form. This enhancement band is used here to carry a unidirectional baseband Ethernet signal, such as Gigabit Ethernet, in the optical domain to all or a subset of subscriber premises to carry broadband services from, for instance, a video on demand distribution facility. This results in a network with all digital baseband signaling and simplifies the network architecture so as to be all Internet Protocol and/or all Ethernet compatible.

### FIELD OF THE INVENTION

This invention relates to optical fiber communications systems and more specifically to broadband optical communications.

### BACKGROUND

Optical communications are well known; typically, optical communications transmit optical (light) signals over optical fibers. Such systems are well known, for instance, in the cable television field, and generally are applicable to telecommunications. In the past, two types of optical fiber distribution systems have been deployed. The first is called Fiber to the Curb (FTTC). In FTTC optical fiber is connected to electronic circuitry at a curbside location. The circuitry at the curb converts optical signals transmitted from a head end along the optical fiber to electrical signals to provide voice, data and video services over, for instance, coaxial cable from the curb to the actual customer's premises. The curb circuitry is powered via the telephone network. A second approach called fiber to the home (FTTH) provides optical fiber directly connected to each home or customer premise, with no circuitry being provided at the curb and instead being at the individual subscriber premises. FTTH tends to be more expensive but has greater subscriber bandwidth. Also well known in this field are passive optical network (PON) which typically provide a bi-directional data channel on a single optical fiber, with upstream traffic transmitted on one wavelength and downstream traffic transmitted on a second wavelength. In this context, a passive optical network connects a feeder optical fiber from a central office to a passive terminal and distributes the transmitted optical signals over distribution optical fibers to each of, typically, 16 to 32 optical network units. The optical network units convert the signals from optical to RF (electrical) form at or near the subscriber premises. Passive optical networks reduce costs by sharing the costly central office infrastructure and optical fiber over a number of such optical network units.

Mahoney et al. US Patent publication U.S. 2004/0165889A1 published Aug. 24, 2004 incorporated by reference herein in its entirety entitled “Hybrid Fiber to the Home/Fiber to the Curb Telecommunications Apparatus and Methods” discloses a telecommunication system using a passive optical network configured to serve optical network terminations at the respective ones of a plurality of subscriber premises. The associated customer premises equipment is of a category of devices called ONT (Optical Network Terminal). Each optical network terminal is connected to the optical network unit coupled to the passive optical network and is configured to provide communications for the plurality of subscriber premises or optical network terminals.

Mahoney et al. describes a passive optical network system that operates at optical wavelength of 1310 nm upstream and 1490 μm (nanometers) downstream. Additionally, the known 1550 nm wavelength “enhancement band” is used in Mahoney et al. for downstream video services. The enhancement band is well-known in optical telecommunications and is defined by the International Telecommunication Union (ITU), (see ITU-T G.983.3 “A broadband optical access system with increased service capability by wavelength allocation”) as being the 1539 to 1565 nm band for digital (data) services or the 1550 to 1560 nm band for broadcast video. Note the difference between “digital services” and “digital signaling”. A digital service is e.g. MPEG2 video, digital music, VoIP, etc. Digital services are carried using modulation techniques such as FSK, ASK, QAM, QPSK. Digital signaling (e.g., Gigabit Ethernet) is a carrier of digital services that uses a digital waveform. The above mentioned ITU document at pp. 12-13 refers to “digital service”, not “digital signaling”. See also Appendix III, Table III.1 of this standards document.

Present FIG. 1 is identical to FIG. 2 of Mahoney and illustrates an exemplary telecommunication system 200. The system includes an OLT (Optical Line Terminal) 214 at a central office 210. Also provided is telephony switch 212. The central office 210 also includes a video transmitter 216 and a conventional optical fiber amplifier (Erbium Doped Fiber Amplifier) 218. Optical fibers 215, 217 connect the central office 210 to remote terminal 220. Remote terminal 220 includes a second EDFA 224, which provides amplified optical signals to a wave division multiplexer (WDM) 226 also coupled to the fiber 215 from the OLT 214. The WDM 226 is further coupled to a composite fiber/optical conductor cable 225 that includes electrical conductors for conveying electrical power from a power supply 222.

The composite cable 225 couples a WDM 226 to an optical splitter 230 that serves an optical network unit (ONU) 240 and a plurality of optical network terminations (ONTs) 252 located at subscriber premises 250. There is a plurality of optical splitters 230 from which fiber optic drops 235 extend to the subscriber premises 250, which are also served by the optical network unit 240 via electrical conductors, for instances, coaxial cable or telephone cable drops 245. In this case, fiber optic drops 235 may be used to provide broadband services such as data services and/or video services from video transmitter 216. The conductor drops 245, which are optional, may be used to provide narrow band service such as telephony. This system accommodates video content transmission from video transmitter 216 using the optical enhancement band as described above. Typically, these broadcast video signals are analog NTSC television, which is conventional cable television, or quadrature amplitude modulated (QAM) digital video signals.

### SUMMARY

Telecommunications system such as described above are improved by using the enhancement band to transmit, instead of analog television or QAM video, in one embodiment a unidirectional (downstream only) optical baseband Ethernet-type signal such as Gigabit Ethernet to subscribers. This is referred to here as the Ethernet overlay. The Ethernet format signal carries IP (Internet Protocol) packets. For instance, this enhancement band optical signal can carry video, voice or data, thus providing a network with all digital baseband signaling. An example is to transmit video over IP, using Ethernet-type packets. This also simplifies the system architecture since all transmissions become all IP and/or all Ethernet protocol. The benefits are: 1) end-to-end protocol consistency, which is to say IP/Ethernet from end-to-end, instead of converting to QAM for part of the data, and 2) network convergence, i.e. the same IP/Ethernet network carries all services. A system which enables this includes at the hub (or central office) additional apparatus referred to here as an Ethernet Overlay Gateway (EOG), which transmits, for instance, video signals in Ethernet format over the enhancement band at, for instance 1550 nm optical wavelength. The Ethernet overlay is in addition to the conventional services provided by the conventional optical line terminals at the head end or hub. In another embodiment, the overlay carries ATM (asynchronous transfer mode) cells instead of Ethernet frames.

Corresponding customer premises equipment includes, in addition to the conventional optical receiving components, an Ethernet optical receiver, an Internet Protocol and/or Ethernet protocol packet processor, an Ethernet controller and other circuitry to support receipt of the Ethernet (or Gigabit Ethernet) transmission in the enhancement band.

More generally, in accordance with the present invention digital signaling techniques such as Ethernet or more generally Manchester encoded signals, NRZ (non return to zero) signals and the like are used in conjunction with the optical enhancement band to transmit signals.

In this context, Ethernet refers generally to communications conforming to the IEEE 802.3 standard, and Gigabit Ethernet (GbE) refers to communications conforming to the relevant IEEE provisional 802.3 standard. Gigabit Ethernet is the latest version of Ethernet and offers 1 Gigabit per second bandwidth, approximately 100 times faster than the original Ethernet, yet is compatible with the older forms of Ethernet equipment. The term Ethernet here broadly includes both the older forms of Ethernet communications as well as newer ones, such as Gigabit Ethernet. 1000-Base-T is the standard for Gigabit Ethernet over long haul metallic conductors. Gigabit Ethernet includes what is called the MAC layer, which uses the same CSMA/CD protocol as original Ethernet. Other aspects of Ethernet are not explained here as being well known in the field.

### BRIEF DESCRIPTION OF THE DRAWINGS

FIG. 1 shows a prior art telecommunications network.

FIG. 2 shows a head end or central office in accordance with this disclosure.

FIG. 3 shows an example of an Ethernet overlay gateway, which is a part of FIG. 2, in accordance with this disclosure.

FIG. 4 shows an example of customer premise equipment in accordance with this disclosure.

### DETAILED DESCRIPTION

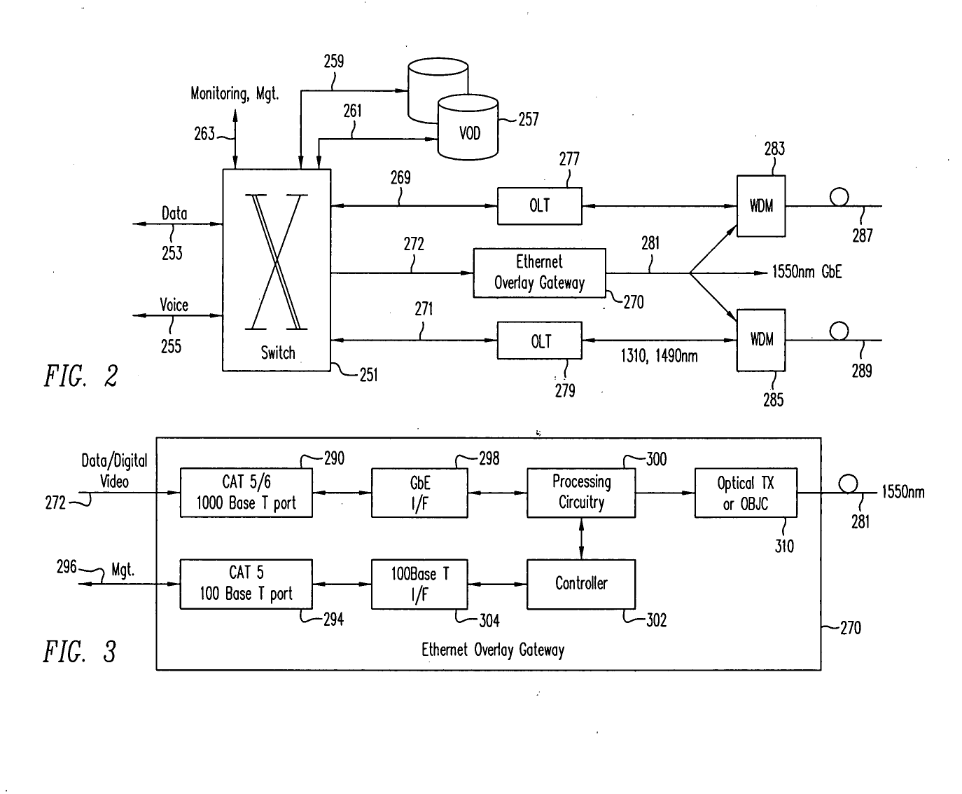

FIG. 2 shows in a block diagram exemplary (primary or local) head end or central office apparatus in accordance with this disclosure for providing the Ethernet overlay. Each block (except for the Ethernet overlay gateway) is conventional, and generally conformed to the applications of passive optical networks as explained above. The left most element 251 is a conventional switch, for instance, an Ethernet switch, SONET switch, SDH switch, or RPR switch. RPR is Resilient Packet Ring standard IEEE 802.17, transporting Ethernet in a ringed network architecture. Switch 251 has the capability of receiving and transmitting suitable electrical digital signals, for instance Ethernet-type signals for video or data or voice to and from switch 251 on respectively lines (electrical conductors) 253 and 255. Also, there may be other inputs and outputs to/from switch 251, for instance representing digital video supplied on lines 259, 261. Generally in this embodiment switch 251 switches digital data packets, for instance, IP (Internet protocol) packets or Ethernet frames. Also provided here is a source 257 of digital video on demand, which is connected via lines 259, 261 to switch 251. Here source 257 is a set of video data servers outputting IP compatible video. Also provided for switch 251 is a management port 263, which is conventional for control of switch 257. Other conventional elements at the head end are a plurality of conventional OLTs 277, 279, etc.

Each OLT 277,279 as shown is connected to the switch 251 for transmission of baseband Ethernet signals on respectively conductors 269, 271. There may be more OLTs than are shown here. The number of OLTs supplied by one port of a switch varies by equipment vendor. The key is one port providing enough bandwidth to support the number of downstream users. Each OLT is connected via an optical path, such as optical fiber, to an associated wavelength division multiplexer (WDM) respectively 283, 285. Each wavelength division multiplexer is then coupled to an optical fiber span respectively 287, 289. The downstream transmissions from each OLT are at 1490 nm wavelength in one example and the upstream transmissions from the respective optical fiber spans 287, 289, which originate at the customer premises or at an optical network unit, would be transmitted upstream at 1310 nm, but this also is merely illustrative. All of these aspects of the head end in FIG. 2 are conventional.

In addition at the head end there is additional apparatus referred to here as Ethernet overlay gateway 270, which is connected via conductors 272 to the switch 251. The Ethernet overlay gateway 270 thus receives downstream electrical signals (hence unidirectional in this case) from switch 251, converts them to suitable Ethernet or Gigabit Ethernet optical signals, and transmits them in the optical enhancement band over optical path 281. These transmissions typically include video (from source 257) or other services (data or voice) in Ethernet compatible format and also in Internet Protocol format. This results in a network with digital baseband signaling and simplifies the system architecture, as described above. In this embodiment Ethernet overlay gateway 270 provides unidirectional (downstream only) transmissions.

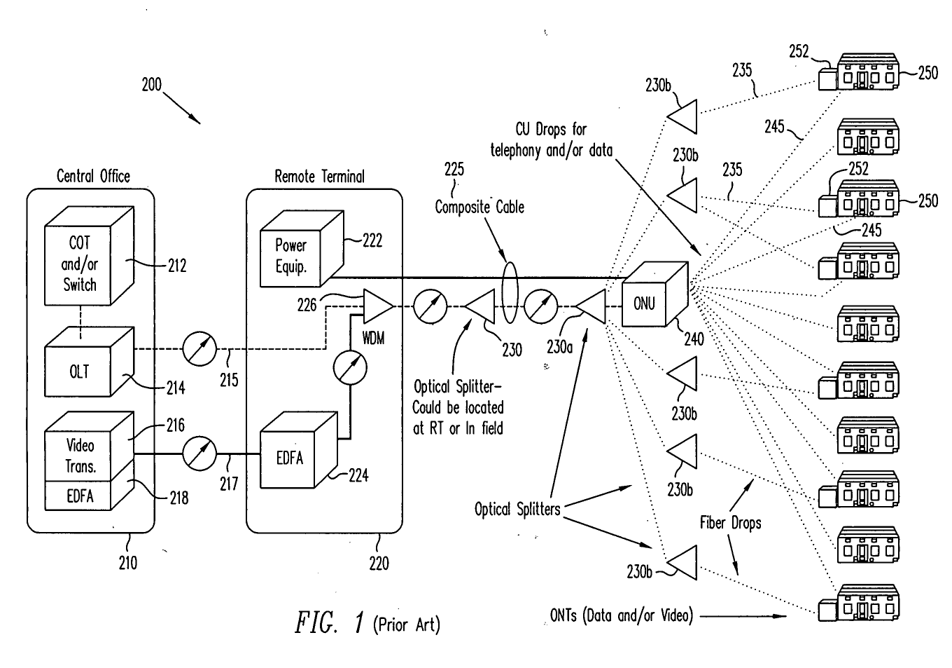

Ethernet overlay gateway 270 (this nomenclature is not limiting, but merely intended to designate apparatus having functionality as described herein) is shown in further exemplary detail in block diagram FIG. 3. Ethernet overlay gateway (EOG) 270 is an electrical to optical converter (optical transmitter) outputting, in this case, a 1550 nm wavelength Gigabit Ethernet compatible optical signal. The Ethernet overlay gateway 270 as shown in FIG. 1 could have multiple splits 281, for sending optical signals over several multiple passive optical networks.

Each block shown in FIG. 3 is, on its own, conventional. The Ethernet overlay gateway 270 has in this example two ports, the first port 290 adaptable to be coupled to CAT5/6 1000 Base-T conductors 272. Port 290 receives on line (or lines) 272 conventional digital video from switch 251. Also provided is a management interface port 294, which is CAT5 100-Base-T compatible and coupled to line (or lines) 296 for receipt and transmission of management commands.

The digital video received at port 290 on lines 272 is transmitted to a conventional Gigabit Ethernet interface 298 conforming to the IEEE GbE physical layer protocol. The digital video, which is then in Gigabit Ethernet format, is transmitted to processing circuit 300, still in the electrical domain. An example of EOG processing by circuit 300 is IGMP proxy or UDLR endpoint. The signals transmitted from processing circuitry 300 to optical transmitter 310 are typically (electrical domain) Ethernet type frames.

Processing circuitry 300, for instance an FPGA suitably programmed, is conventionally controlled by a controller (microprocessor) 302, which is coupled to the management interface port 294 via a conventional 100 Base-T interface 304. The functions controlled in the processing circuitry 300 by controller 302 include those mentioned immediately above. The processed Ethernet compatible data, still in the electrical domain, then is coupled into a conventional 1550 nm optical transmitter or GBIC 310. GBIC refers to Gigabit interface converter, which is a type of known transceiver that converts serial electrical signals from processing circuitry 300 to serial optical signals. GBICs are well-known to interface a fiber optic system with an Ethernet system such Gigabit Ethernet. GBIC devices are commercially available from a number of sources. The optical transmitter/GBIC 310 then outputs to optical fiber 287, as also shown FIG. 2, a 1550 nm wavelength optical signal, which is then split up and conveyed to the various WDMs 283, 285 shown in FIG. 2.

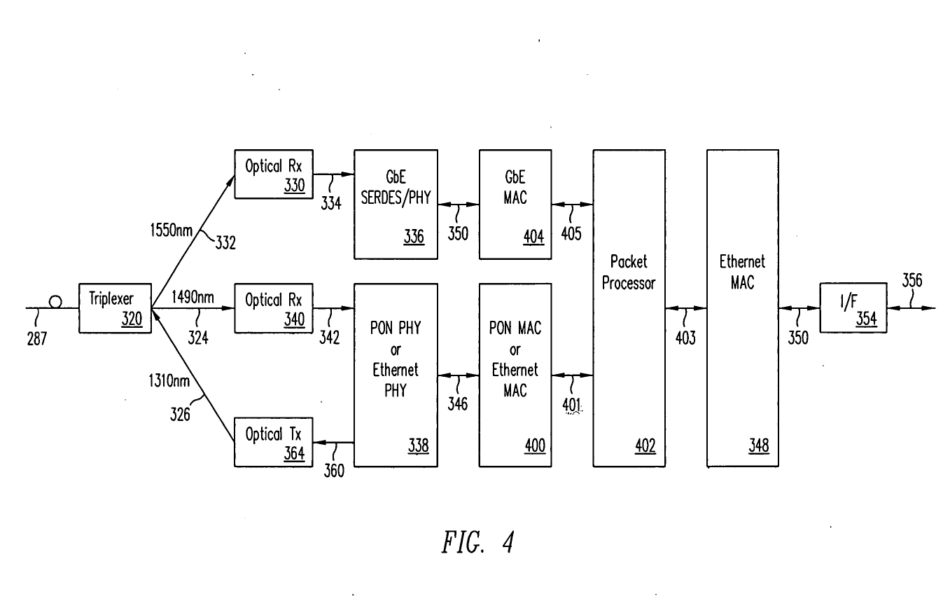

The remainder of the associated telecommunications network connected to WDMs 283, 285 is conventional as well-known in the field, except for suitable adaptations at the customer premises equipment shown in FIG. 4. Customer premises equipment here refers to both the equipment located at or near the individual customer premises as in fiber to the home or as in fiber to the curb.

In FIG. 4, optical fiber 287 is the same as shown in FIG. 2 from the central office/head end or hub. (In this context head end may refer to a local head end.) Optical fiber 287 is connected to triplexer 320, which is a conventional optical fiber component. The downstream optical signals at 1550 nm and 1490 nm wavelengths are respectively output from triplexer 320 on optical paths 332 and 324. In this case, the 1550 nm wavelength carries the enhancement band optical signal as described above. The 1550 nm wavelength signal is coupled into a conventional optical receiver 330, for instance, part number STX-48-MS from Optical Communications Products. Optical receiver 330 converts the 1550 nm optical signal to an electrical signal on electrical conductor or electrical transmission line 334, which is connected to the Gigabit Ethernet physical (or PHY) receiver 336. The use of the enhancement band here, of course, is not limited to the 1550 nm wavelength shown, but can be any other wavelength in the enhancement band. Also, of course, use of wavelengths here of 1310 nm for the upstream path and 1490 nm for the downstream path is not limiting, but merely illustrative.

Ethernet PHY receiver 336 is e.g. a conventional 8B/10B SERDES (serializer/deserializer) Ethernet receiver such as part no. VSC7123 from Vitesse Semiconductor. The resulting digital Gigabit Ethernet electrical signals on line 350 are coupled into an Ethernet MAC device 404. The Ethernet MAC device converts the physical layer interface to the media access layer. MAC 404 outputs the relevant signals on lines 405 to a packet processor circuit 402. Note that connections 350 and 405 is bi-directional since the PHY and MAC layers exchange information based on the IEEE 802.3 specification.

The 1490 nm wavelength signal on optical path 324 is coupled into a second optical receiver 340 (e.g. part no. DTR-156-3.3-SM-A-LO-LR1-N transceiver from Optical Communications Company), which in turn outputs an electrical signal on electrical conductor lines 342 and couples into the receive port of Ethernet PHY receiver 338. The resulting digital Ethernet electrical signals on line 346 are coupled into an Ethernet MAC or PON MAC device 400. The MAC device 400 converts the physical layer interface to the media access layer. MAC 400 outputs the relevant signals on lines 401 to a packet processor 402.

Packet processor 402 processes IGMP packets from the interface 354 portion of the device, filters the incoming multicast video streams from the enhancement band (blocks 332, 330, 336, 350, 404, 405) and multiplexes the filtered streams from the enhancement band (blocks 332, 330, 336, 350, 404, 450) with the packets from the 1490 nm wavelength downstream data band (blocks 324, 340, 342, 338, 346, 400, 401). The packet processor 402 is not limited to these functions and may have additional functions.

The packet processor 402 is connected by electrical lines 403 to conventional Ethernet MAC device 348. The Ethernet MAC device 403 is connected by electrical lines to a coaxial cable or telephony interface 354, which is for instance an HPNA (Home Phoneline Network Association) or MoCA (Media Over Coax Alliance) interface for distribution of the relevant data over an in-home coaxial cable or phone lines 356. For example, interface 354 is a combination of part nos. SCG3011 and CG3012 from CopperGate Semiconductor. Coaxial cable 356 may be connected to a number of subscribers in the fiber to the curb context. HPNA refers to the standard also known as Home PNA v3.0, which is for phone line networking used, for instance inside a building or home using existing installed telephone lines to carry digital data. HPNA allows continued use of home phone lines for conventional voice analog telephony. Interface 356 can be coaxial or phone line, HPNA will operate on either medium. Interface 356 can also be a standard Ethernet PHY to standard CAT5 connection, in the event that the home or business has a 10/100BaseTx connection.

On the upstream data transmission side, data supplied, for instance from a personal computer connected to line 356, is conventionally transmitted back up through interface 354 to packet processor 402 and up to media access controller 400 over interface 401. The upstream data is transmitted from the media access controller 400 on lines 346 to the physical layer device 338. The physical layer device 338 transmits the electrical signals on lines 360 or a second optical transmitter 364, which converts the electrical signals to 1310 nm optical wavelength signals, which are carried on optical path 326 back to the triplexer 320 and hence onto fiber 287 for transmission back up to the head end, as is conventional.

Note that the triplexer 320, optical path 332, optical path 324, optical path 326, optical receiver 330, optical receiver 340 and optical transmitter 364 may be incorporated into a single device. Note also that the GbE SERDES 336, GbE MAC 404, packet processor Ethernet MAC 348 and electrical paths 350, 405, 403 may be incorporated into a single network processor device or FPGA.

This disclosure is illustrative and not limiting; further modifications will be apparent to those skilled in the art in light of this disclosure and are intended to fall within the scope of the appended claims.

What is claimed as new and desired to be protected by Letters Patent of the United States is:

1. Method of transmitting information, comprising the acts of:
providing a digital signal;
putting the digital signal in Ethernet format;
converting the Ethernet format signal to an optical signal having a wavelength in the enhancement band; and
transmitting the optical signal on optical fiber to a destination.

2. The method of claim 1, wherein the Ethernet format signal carries Internet Protocol (IP) packets.

3. The method of claim 1, further comprising the acts of:
providing a data signal, and
transmitting the data signal as an optical signal to the destination on a second wavelength differing from the first wavelength.

4. The method of claim 1, wherein the destination is a subscriber premises.

5. The method of claim 1, wherein the optical signal is transmitted to a plurality of destinations.

6. The method of claim 1, wherein the optical signal carries at least 1 gigabit of information per second.

7. The method of claim 1, further comprising the acts of:
converting the transmitted optical signal at the destination to an electrical signal; and
transmitting the electrical signal on at least one of a telephone line or coaxial cable.

8. The method of claim 1, wherein the act of transmitting includes transmitting the optical signal over a passive optical network.

9. The method of claim 1, wherein the enhancement band is from 1539 to 1565 nm wavelength.

10. The method of claim 1, wherein the digital signal includes at least one of video, data, or voice information.

11. Method for receiving information at a destination, comprising the acts of:
receiving an optical signal transmitted to the destination on optical fibers, wherein the optical signal has a wavelength in the enhancement band;
converting at the destination the optical signal to an electrical signal in Ethernet format; and
deriving a digital signal from the Ethernet format electrical signal.

12. The method of claim 11, wherein the Ethernet format electrical signal carries Internet Protocol (IP) packets.

13. The method of claim 11, further comprising the act of:
deriving at least one of video, data or voice information from the optical signal at the destination.

14. The method of claim 11, wherein the destination is a subscriber premises.

15. The method of claim 11, wherein the received optical signal has been transmitted to a plurality of destinations.

16. The method of claim 11, wherein the optical signal carries at least 1 gigabit of information per second.

17. The method of claim 11, further comprising the act of:
transmitting the digital signal at the destination on at least one of a telephone line or coaxial cable.

18. The method of claim 11, wherein the optical signal is received over a passive optical network.

19. The method of claim 11, wherein the enhancement band is from 1539 to 1565 nm wavelength.

20. The method of claim 11, wherein the Ethernet format signal conforms to Gigabit Ethernet.

21. Optical transmitting apparatus comprising:
a data switch;
a plurality of optical line terminals each coupled to receive data from the data switch, each optical line terminal outputting a first optical signal having a first wavelength;
a wavelength division multiplexer coupled to each optical line terminal; and
an optical transmitter coupled to receive an Ethernet format signal from the switch and to convert the Ethernet format signal to a second optical signal having a second wavelength in the enhancement band, wherein the second optical signal is coupled to at least one of the wavelength division multiplexers for transmission on optical fiber together with the first optical signal.

22. The apparatus of claim 21, wherein the Ethernet format signal carries Internet Protocol (IP) packets.

23. The apparatus of claim 21 wherein the Ethernet format signal includes at least one of video, data or voice information.

24. The apparatus of claim 21, wherein the optical signals are transmitted to a plurality of destinations.

25. The apparatus of claim 21, wherein the second optical signal carries at least 1 gigabit of information per second.

26. The apparatus of claim 21, wherein the Ethernet format signal conforms to Gigabit Ethernet.

27. The apparatus of claim 21, wherein the apparatus is adapted for transmitting the optical signals over a passive optical network.

28. The apparatus of claim 21, wherein the enhancement band is from 1539 to 1565 nm wavelength.

29. The apparatus of claim 21, wherein the optical transmitter includes a Gigabit interface converter (GBIC).

30. The apparatus of claim 21, wherein the optical transmitter includes a processor coupled to receive management commands.

31. The apparatus of claim 21, wherein the optical transmitter is coupled to the data switch at a port conforming to the 1000 Base-T standard.

32. Optical receiving apparatus comprising:
an optical demultiplexer adapted to be coupled to an optical fiber;
an optical receiver coupled to the optical demultiplexer to detect an optical signal supplied from the optical fiber having a wavelength in the enhancement band;
an Ethernet receiver coupled to the optical receiver; and
a media access controller coupled to the Ethernet receiver to output a signal in Ethernet format from the optical signal.

33. The apparatus of claim 32, wherein the Ethernet format signal carries Internet Protocol (IP) packets.

34. The apparatus of claim 32, wherein the Ethernet format signal includes at least one of video, data, or voice information.

35. The apparatus of claim 32, wherein the apparatus is suitable to be installed at a subscriber premise.

36. The apparatus of claim 32, wherein the optical signal is received at a plurality of destinations.

37. The apparatus of claim 32, wherein the optical signal carries at least 1 gigabit of information per second.

38. The apparatus of claim 32, further comprising:
an interface coupled to transmit the Ethernet format signal on at least one of a telephone line or coaxial cable.

39. The apparatus of claim 32, wherein the apparatus is adapted to couple to a passive optical network.

40. The apparatus of claim 32, wherein the enhancement band is from 1539 to 1565 nm wavelength.

41. The apparatus of claim 32, wherein the Ethernet format conforms to Gigabit Ethernet.

42. The apparatus of claim 32, further comprising a second optical receiver coupled to the optical demultiplexer to detect a second optical signal supplied from the optical fiber at a wavelength differing from that of the first optical signal.

43. The apparatus of claim 32, further comprising an optical transmitter coupled to the optical demultiplexer.

44. The apparatus of claim 32, wherein the optical demultiplexer is one of a diplexer or triplexer.

45. The apparatus of claim 32, further comprising an interface circuit coupled to the media access controller and adapted to receive signals from and transmit signals to the data switch and at least one of a coaxial cable or telephone line.
